(19) United States
(12) Patent Application Publication
(10) Pub. No.: US 2003/0009474 A1
(43) Pub. Date: Jan. 9, 2003

(54) Binary search trees and methods for establishing and operating them

(76) Inventors: Kevin J. Hyland, Dublin (IE); Kevin Jennings, Ballinasloe (IE)

Correspondence Address: NIXON & VANDERHYE P.C., 8th Floor, 1100 North Glebe Rd., Arlington, VA, 22201-4714, US

(21) Appl. No.: 09/930,189

(22) Filed: Aug. 16, 2001

(30) Foreign Application Priority Data
Jul. 5, 2001 (GB) 0116541.4

(51) Int. Cl. G06F 7/00

(52) U.S. Cl. 707/102

(57) ABSTRACT

A binary search tree including a multiplicity of nodes having pre-determined addresses and organised in a multiplicity of levels, and a hardware engine for the insertion of elements in the nodes. Being operable to make a search for the highest available node in a pattern in which all the nodes at each level beginning at the highest are searched before the search continues to the next lower level.

### FIELD OF THE INVENTION

The present invention relates generally to binary search trees and methods of operating them particularly although not exclusively to enable look-ups in packet-based communication networks, so as for example to provide forwarding information (such as a port number of a switch) for a packet of which the address is stored in a look-up.

### BACKGROUND TO INVENTION

One of the biggest bottlenecks in a switch design is the look-up process. A process called hashing is commonly adopted whereby (for example) the MAC address of a device is encoded to a smaller value and stored in memory using that value as an address. Thereby rather than implementing a search of a 48 bit number, the hashed value is used to retrieve the stored MAC address. However, often at least two different MAC addresses can hash to the same value and a linked list of entries under the same hashed MAC address must be constructed inferring an unpredictable latency to the switch. Statistically, the list increases rapidly the smaller the amount of memory available to store the addresses. One could have an example where there is a long list of entries at one hashed address despite the fact that there may be hashed addresses that have not yet been used.

A binary search tree is a data structure adopted predominantly in software that yields an efficient algorithm for searching through a large database for a particular entry. The structure has a few key characteristics. For convenience each location in the tree is termed a ‘node’ and the information contained therein is called an ‘element’.

Every binary search tree has a unique root node separating to other binary search trees. These two binary trees are disjoint from each other and from the root node and are called the left and right subtrees of the root. These subtrees are themselves binary search trees in their own right. Each time one moves from a node to one of its subtrees, a ‘level’ in the tree is traversed. If a binary search tree has L levels the root node is the only node to be a member of level L, the uppermost level. A full binary tree with L levels has (2ˆ L)−1 nodes.

Inherent in the levels of the tree is a hierarchical structure. For any node at some level X there is a unique ‘parent’ node at level X+1 and two ‘children’ at a level X−1.

Searching the tree call be optimised by the following rules applied at any node with element B.

a) If A is ANY element in the left subtree of B, then A is less than B.

b) if C is ANY element in the right subtree of B, then C is greater than B.

For a given number of nodes there is an associated minimum tree depth that yields maximally efficient searches for any given element of that tree. A tree whose depth is minimal for a given number of entries is called a ‘balanced’ tree. However, in compiling a tree from a succession of, for example, randomly occurring values within a range that is to be encompassed by the tree, the tree is likely to be unbalanced, especially if implemented in hardware.

If a binary tree is (as is usual) implemented in software the hierarchy of the tree is formed by linking nodes with pointers to other nodes. Along with the actual element two pointers are also contained at every node one to the memory location of the left subtree and one to the right subtree. As usual, pointers are simply memory addresses. In hardware storing this kind of information occupies unnecessary area on a chip often a more critical aspect of design than the latency of a look-up process. However, latency is also an important consideration in hardware designs especially in time critical applications.

### SUMMARY OF THE INVENTION

The present invention is based on the dynamic construction of pointers to neighbouring nodes using simple logic, saving the area otherwise needed to store these pointers statically for every node in the tree.

A tree implemented in accordance with the invention is always balanced because every new element is inserted at the “highest” available node in the hierarchy of the tree. Thus for a full tree of L levels there is a worst case of L possible comparisons before the search element can be located.

A binary search tree according to the invention offers a deterministic minimal search latency for any element (such as a MAC address) stored in one of its nodes because (a) every memory address points to one other element only: and (b) the search algorithm adopted to find an address in the database has a fixed worst case value fixed by the size of the look-up memory available. The invention is therefore particularly suited for implementation in hardware with minimal memory.

Further objects and features of the invention will be apparent from the following detailed description with reference to the accompanying drawings.

### BRIEF DESCRIPTION OF THE DRAWINGS

FIG. 1 is a schematic illustration of a network switch.

FIG. 2 illustrates a software structured balanced binary search tree.

FIG. 3 illustrates a software structured unbalanced binary search tree.

FIG. 4 illustrates part of an insertion process.

FIG. 5 illustrates the result of a shuffling process.

FIG. 6 illustrates memory locations restructured as a binary search tree.

FIG. 7 illustrates the general structure of a binary, search tree with level decode.

FIG. 8 illustrates a searching flow algorithm.

FIG. 9 illustrates neighbouring code locations in a binary search tree.

FIG. 10 illustrates a search path for finding a highest available new node.

FIGS. 11 and 12 illustrate a flow chart algorithm for inserting new elements.

FIG. 13 illustrates a flow chart for a deletion algorithm.

### DETAILED DESCRIPTION

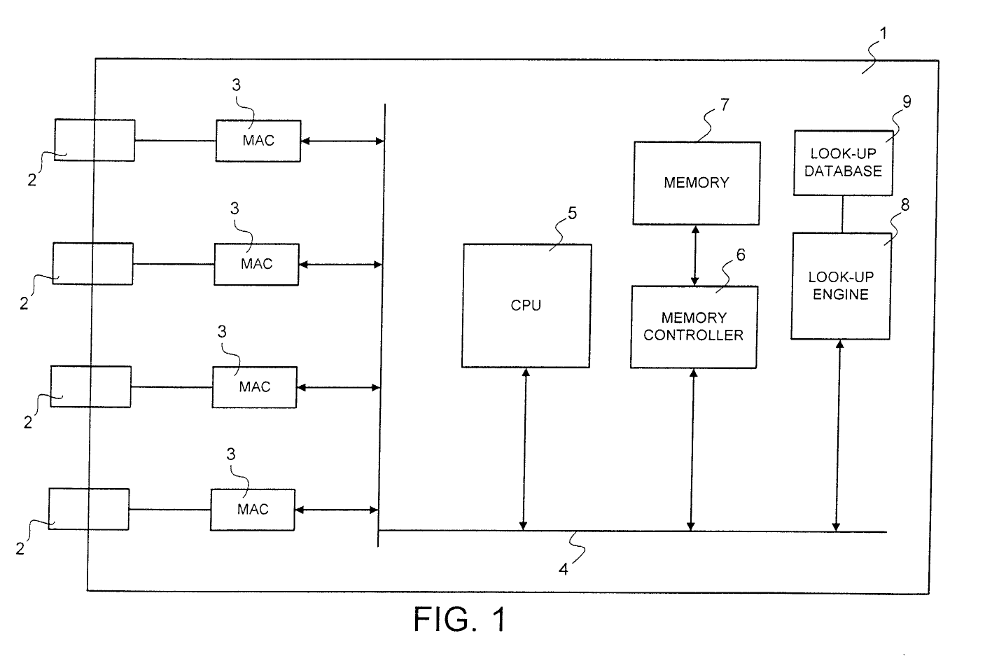

FIG. 1 illustrates for the sake of a specific example one form of device within which a binary search tree may be used in accordance with the invention. The example given is of an otherwise well known form of switch which can be used in a packet-based communication system, conforming for example to an Ethernet protocol and particularly IEEE Standard 802.3 (1998 Edition). In view of the generally well known nature of the switch which in practice is of considerable complexity, the switch shown in FIG. 1 has been deliberately simplified.

The switch 1 shown in FIG. 1 has a multiplicity of ports 2. In practice there are many more ports than the four shown. These ports are capable of receiving addressed data packets or other frames from a communication medium and also transmitting addressed data packets. The ports are coupled to media access control (MAC) devices 2 which are intended to be in well known form. Packets received by any of the ports are after appropriate pre-processing passed by way of a memory bus system coupled to a CPU 5, to a memory controller 5 controlling reading and writing in a memory 7 which may be located ‘on-chip’ but may be off-chip according to preference. Coupled to the bus system is a look-up engine 8 having access to a look-up database 9. In practice the look-up engine 8 may be part of the processing system represented by the CPU 5 but depending on the organisation of the switch there may be a multiplicity of look-tip engines, a multiplicity of processors and so on. A typical example of a modern complex multi-chip switch, wherein there are mutually coupled look-up engines and network processors, is described in the earlier application of O Callaghan et al. Ser. No. 09/818,670 filed Mar. 28, 2001 and commonly assigned herewith filed Jan. 30, 2001. Another form of switch is described in application of Creedon et al, filed Jun. 29, 2001, and entitled ‘ASIC SYSTEM ARCHITECTURE INCLUDING DATA AGGREGATION TECHNIQUE’ and commonly assigned herewith.

One process which the switch commonly has to perform is a look-up based on address data within a received packet in order to determine the destination or group of destinations to which a packet or replicas of a packet should be forwarded. The look-up database 9 is used for this purpose. Typically it comprises a multiplicity of entries at specific memory locations, the entries including ‘associated data’ which (among other things) includes the forwarding data for the relevant packet. Typically the forwarding data identifies for example by means of a bit mask, the particular ports from which a packet having the particular destination address should be forwarded. This look-up process is commonly known as a ‘destination address look-up.’

A look-up database of this nature is commonly at least part established by performing an additional look-up, known as a source address look-up wherein, for example the look-up database is examined to see whether there is an entry corresponding to the source address of an incoming packet. If there is no such entry a new entry can be made including an identification of the port on which the packet having that source address was received.

It will be understood by those skilled in the art that this a brief description of a process which can involve other operations, having regard to forwarding rules in the network. VLAN membership spanning tree algorithm trunking rules and so on.

The relationship between a packet and the entry in the look-up database is exemplified as follows. A packet usually has a preamble. MAC address data, typically including a 48-bit destination address and a 48-bit source address a further section, which may include control data. VLAN data, network (layer 3) addresses and so on, a message section (comprising the data ‘payload’ of the packet) and a cyclic redundancy code section. Typically, there is a search made on part of the MAC address data to locate a corresponding element or entry In the look-up database, this entry providing access to associated data.

There is quite a variety of ways in which the search can be organised, both in hardware and software. The principal problem is that the address data or search key is commonly very long, (typically 48 bits) and the number of different entries that many have to be made may be very large. Considerable effort has been devoted to the achieving of efficient, large capacity, search structures and algorithms.

In these and other circumstances the binary search tree offers a convenient and deterministic minimal search latency because every memory address is associated with a single MAC address and the search algorithm has a fixed worse case value fixed by the size of the look-up memory available.

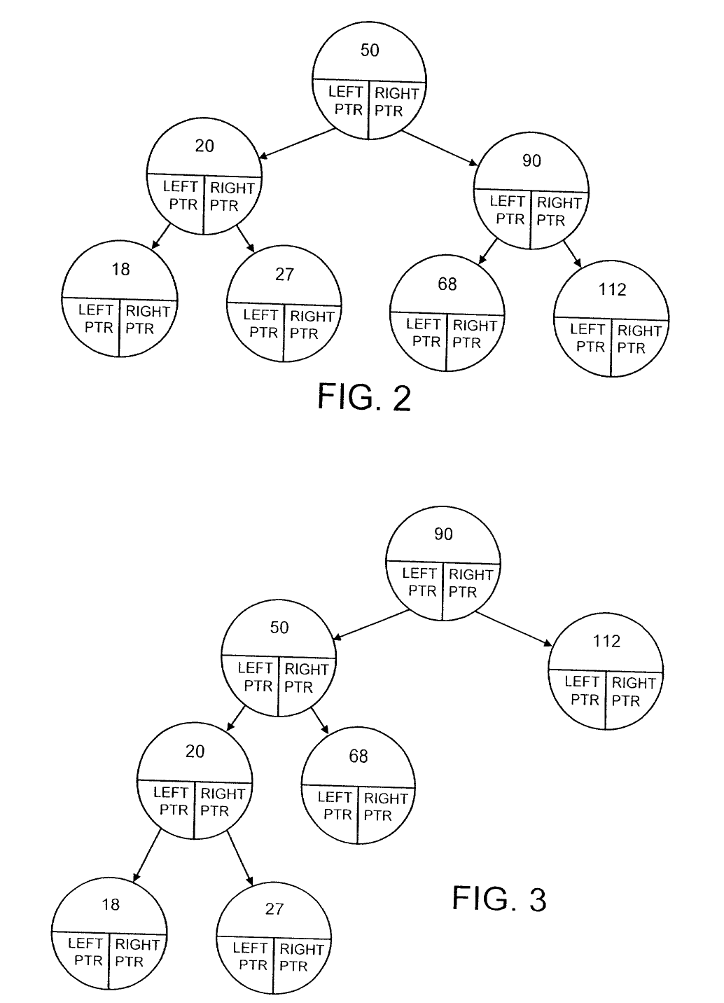

FIG. 2 schematically represents a balanced binary search tree which is structured in software. Each node (except the final leaf nodes) has to pointers to the left and right. A binary search is made by comparing the value of the key with the element at the root node. The search terminates if the key is equal to that element, which is 50 in the example. If the key is not equal to the element then one or other of the nodes identified by the pointers is accessed next, depending on whether the key is greater or less than the element at the examined node.

Each entry includes or has a pointer to associated data (not shown in FIG. 2) as well as a left pointer and a write pointer, which in accordance with ordinary practice are merely addresses in which the elements of the adjacent nodes are stored.

It is desirable to achieve a balanced tree in order to minimize the number of operations required to achieve a match between the keys and the address data in the entry.

It should be understood, in relation to FIG. 2, that the actual location in memory of the entries shown is unimportant except for the root node. A search is made by comparing the address (or key) with the element in the root node. If there is identity the, search ends immediately. The search proceeds down the left tree if the key is less than the element in the root node and down the right tree if the key is greater than the element in the root node. Thus for example when searching the tree in FIG. 2, if the key is less than 50 the next stage of the search is directed by the left pointer to the entry ‘20’. On the contrary, if the address key is greater than ‘50’ the right pointer will be used to access the node shown with element ‘90’ and a further stage of comparison occurs and so on.

FIG. 2 is balanced with the same depth of tree both to the left and to the right of the root node because it is constructed ex post facto, it being known that ‘50’ is the middle value of the elements. In practice unbalance occurs owing to the fact that the entries may have to be compiled in an uncontrolled order. This is shown in FIG. 3. The root node is established first and contains the element 90. Thus it will be seen that the number of nodes and the depth of the tree is greater on the left-hand side of FIG. 3 than the right-hand side. If for example the next entry had an element ‘24’, the tree should be traversed down to the node having address key ‘27’ and should be established using the left pointer available for that node, making the tree further unbalanced. The unbalance will occur if the elements that are established after the root node are preponderantly greater (or less) than the element at the root node.

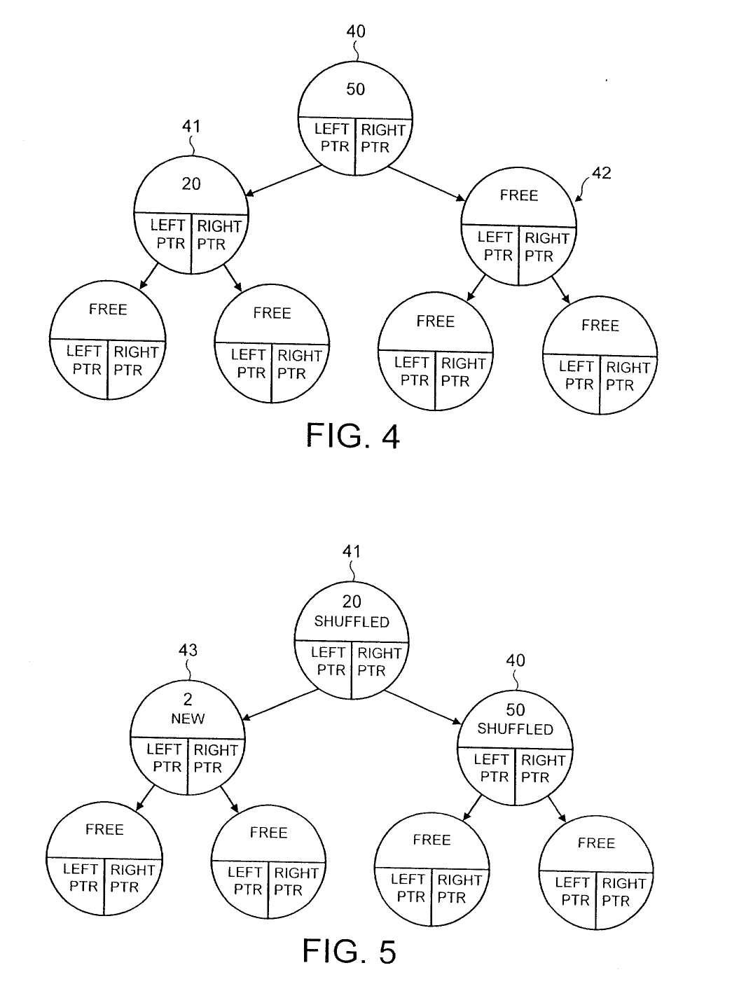

In order to alleviate delays caused by unbalanced trees, it is known to ‘shuffle’ the elements in the nodes. This is shown in FIGS. 4 and 5. In FIG. 4 node 40 contains element ‘50’ and node 41 contains element ‘20’. Node 42, the other ‘child’ of node 40, is the highest (in terms of levels) available node. If the next element to be stored in ‘2’, less than the element in node 41, it will be put in one of the child nodes of node 41, tending to unbalance the three. It is known to perform a shuffling operation as shown in FIG. 5, wherein node 41 becomes the root node and node 40 a child of the root node. The new element ‘2’ is put into node 43 and the tree is balanced.

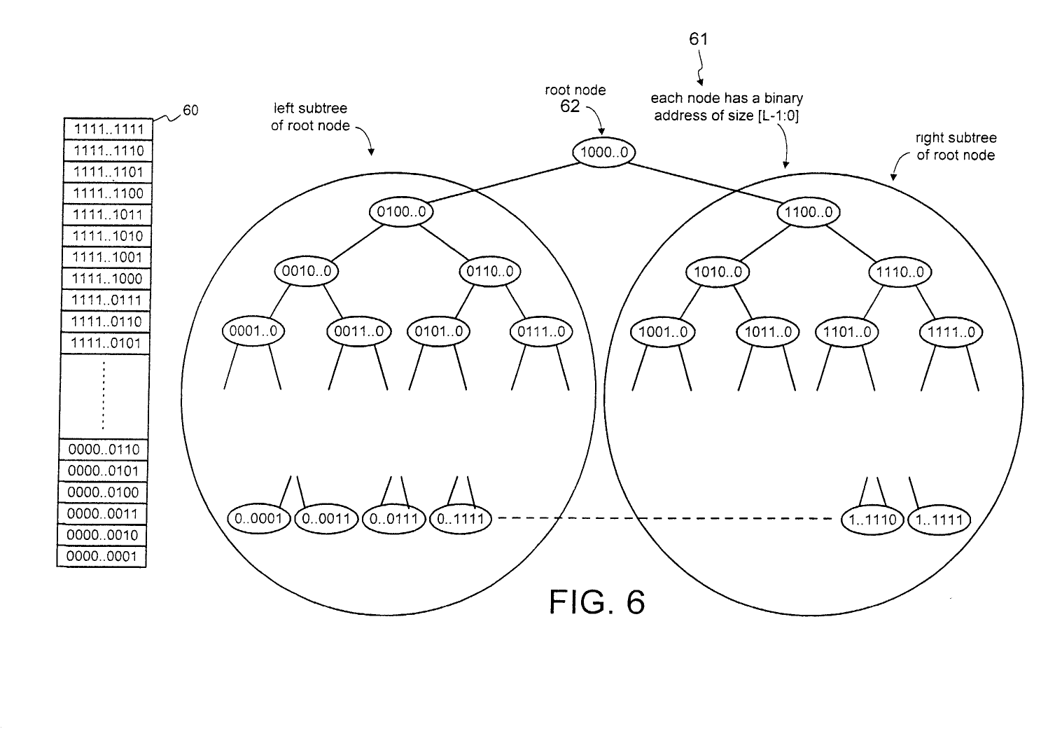

FIG. 6 illustrates an array 60 of standard hardware memory locations, each defined by a multiple binary word. The array 60 of memory locations can be organised as a binary tree 61 from a root node 62. The tree 61 has nodes corresponding to the addresses in array 60 and except for the leaf nodes (i.e. at the lowest level) each node has two child nodes of which the addresses can simply be computed from their parent node.

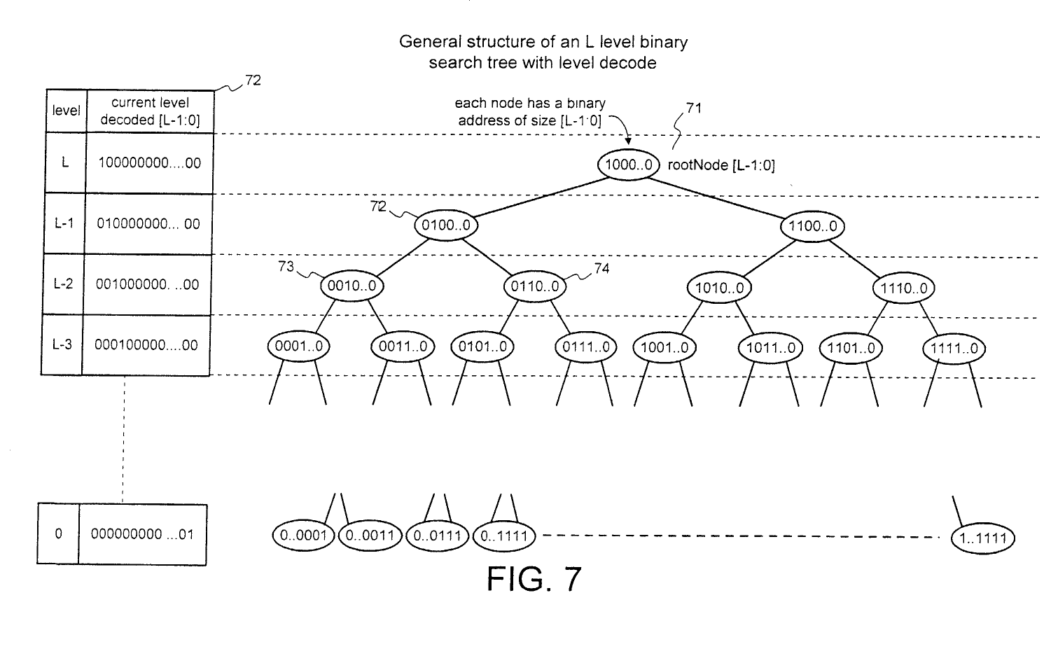

FIG. 7 illustrates a binary search tree which is provided with an explicit hierarchy represented by a ‘level decode’. Each address has a binary size of L bits, usually represented conventionally as [L−10]. Shown adjacent the tree 71 in FIG. 7 is a decoding scheme 72 identifying each level from 0 to L with the address of the first node at the respective level. Owing to its binary nature a tree with L levels may be constructed with a number of locations corresponding to (2^{L})−1.

It should be noted that in FIG. 7 the tree 71 has a predetermined structure such that for each level, each node has two child notes of which the right-hand node has an address greater than the address of the left-hand node and each is simply computable from the address of the parent node. Thus for example the address [0100 0] of node 72 can generate the address [0010 0] of node 73 and the address [0110.] of node 74 by diminishing and augmenting respectively the address of node 72 by the binary value 2^{m} where m is one fewer than the level of the parent node in accordances with the ordering of a binary tree.

Knowing the level for any node of interest allows the calculation of ‘pointers’ to neighbouring nodes. Knowing these will in turn allows the implementation of simple algorithms which are used to search for an element and for inserting and deleting new elements in the tree and which can be performed by hardware logic. These pointers are not stored on a per node basis, they are dynamically calculated when needed.

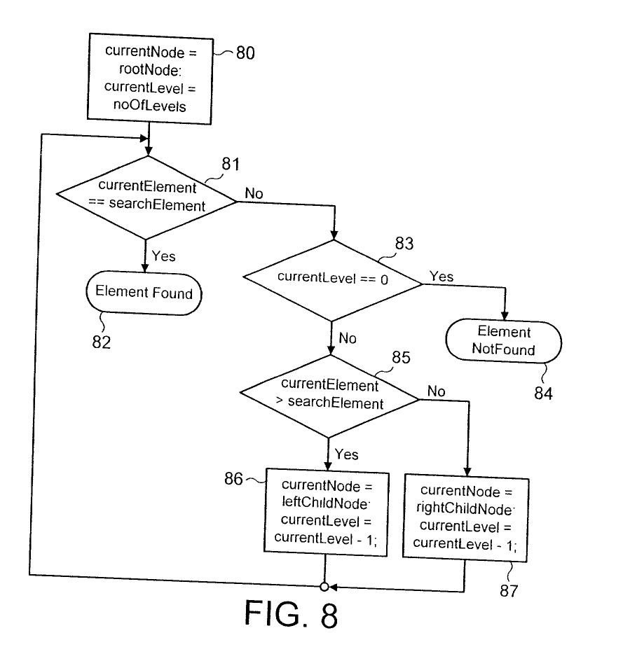

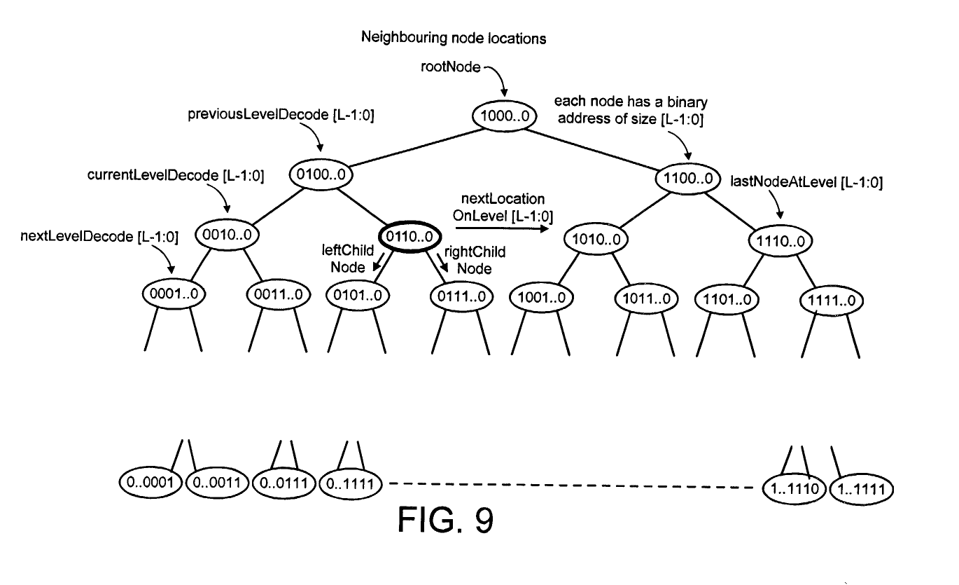

Accordingly, if the tree is structured as shown in FIG. 7 then the flow algorithm employed in FIG. 8 may be used when searching for an element. In this and the other flow diagrams a single equals sign represents the action ‘set (parameter) equal to (stated value)’ so that for example in the first stage 80 the Variable ‘current node’ is set to the root node and the VARIABLE ‘current level’ is set to the number of levels. The double equals sign represents the discovery of identity, so that for example in stage 83, a test is made to determine whether the current level is identical to zero.

According to the flow algorithm in FIG. 8, the comparison stage 81 discovers whether the current element is identical to the key or search element. If the current element is identical to the search element then the element has been found (stage 82) and in the specific example, the associated data is retrieved. If the current element is not identical to the search element, then a test is made (stage 83) whether the current level is identical to zero. If it is, then the search has been completed unsuccessfully and the element is not found in the search table. If the current level is not identical to zero, the next test (85) is whether the current element is greater of less than the search element. This is the basic stage of a binary search tree. The search is then directed either to the left child node or the right child node according to whether the current element is less than or greater than the search. By virtue of the structure just discussed the ‘current’ node is set to the appropriate child node and the ‘current’ level is decreased by unity. The search reverts to stage 81 and so on.

It is worth mentioning here that the tree structure and the level decoding allows the computation of nodes neighbouring a randomly selected node and also allow the determination whether a node is the first or last at a given level.

Consider a randomly selected node n at memory address currentNode[L 0].

a) currentLevel Decode Knowing the level at which a node resides, say X, one calculates a decode of it as follows.

currentLevelDecode[L X+1]=0

currentLevelDecode[X]=1′b1

currentLevelDecode[X−1 0]=0

b) The parent node is the node immediately above a randomly selected node. The only node not to have a parent is the root node.

parent[L 0]=((˜currentLevelDecode[L 0])&currentNode[L 0])|(previousLevelDecode[L.0])

c) The RightChildNode is the node which resides to the right of a randomly selected node. The element of the right child node is greater than the element contained at node n.

rightChildNode[L 0]=currentNode[L 0]|nextLevelDecode[L 0]

d) The LeftChildNode is the node which resides to the left of a randomly selected node. The element of the left child node is less than the element contained at node n.

leftChildNode[L 0]=currentNode[L 0]|nextLevelDecode[L 0]

e) previousLevelDecode=the level at which a node's parent resides, decoded previousLevelDecode[L 0]=currentLevelDecode[L 0]<<1

f) nextLevelDecode=the level at which a node's child/children reside, decoded nextLevelDecode[L 0]=currentLevelDecode[L 0]<<1

g) nextLocationOnLevel. The next location on a level is the node directly to the right of n.

nextLocationOnLevel[L 0 ]=currentLocation[L 0]+previousLevelDecode[L 0]

h)lastNodeAtLevel. The last node on the level at which n resides.

lastNodeAtLevel[0]=currentLevelDecode[0]:

lastNodeAtLevel[1]=currentLeveldecode[1]|lastNodeAtLevel[0]:

lastNodeAtLevel[2]=currentLeveldecode[2]|lastNodeAtLevel[1]:

lastNodeAtLevel[3]=currentLeveldecode[3]|lastNodeAtLevel[2]:

lastNodeAtLevel[L]=currentLeveldecode[L]|lastNodeAtLevel[L−1].

i) firstNodeAtLevel. The first node on the level at which n resides

firstNodeAtLevel[L0]=currentLevelDecode[L 0]

The relationships between the nodes are summarized in FIG. 9.

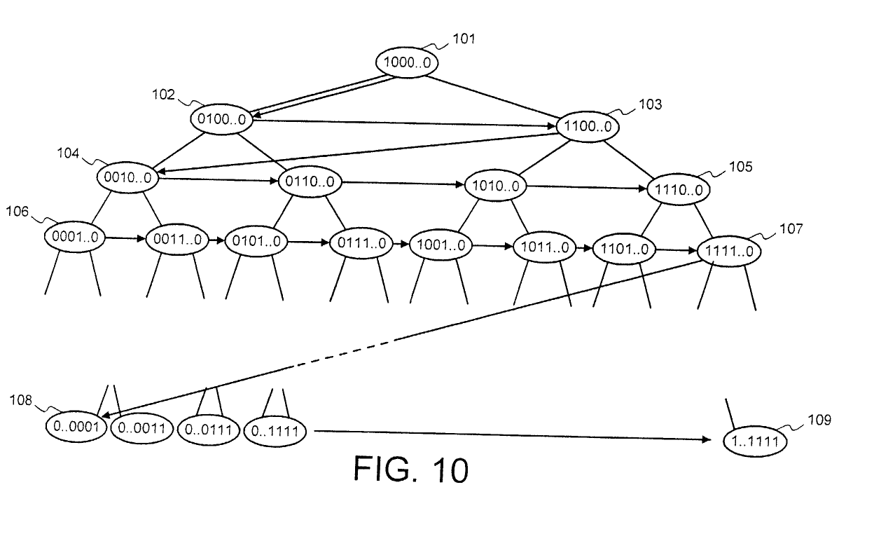

FIG. 10 illustrates the pattern for the search for new unoccupied nodes when inserting a new element. The search commences at the root node 101, then proceeds along the next level (L−1) for nodes 102 and 103, then proceeds along the next level (L−2) that is to say nodes 104 to 105 and so on to the next level of which the first node is 106 and the last node of the level is 107. At each level a test can be made in accordance with the foregoing to determine whether the node is the last node on that selected level so that a next level decode performed still produce a pointer to the first node (for example 102, 104, 106) on the next level down. In the Figure, node 108 may be termed the ‘base’ node, the first node of the lowest level and node 109, shown with an address of all ones, is the terminating node.

The remaining Figures are flow diagrams illustrating the operation of hardware logic for (a) inserting new elements in the binary tree and (b) deleting elements from the tree. In a specific embodiment the nodes constitute, or form part of the look-up database 9 in FIG. 1 and the logic engine performing the insertion and deletion processes as well as the search process described in FIG. 8 forms part of the look-up engine 8 in FIG. 1.

FIG. 11 is a flow chart of an algorithm for the insertion of new elements. It commences with stage 111. Which the ‘current’ node, that is to say the node in respect of which operations are being performed, is set to the root node. The other parameter which needs setting is the ‘current level’ which is set to the number of levels in the tree (L)

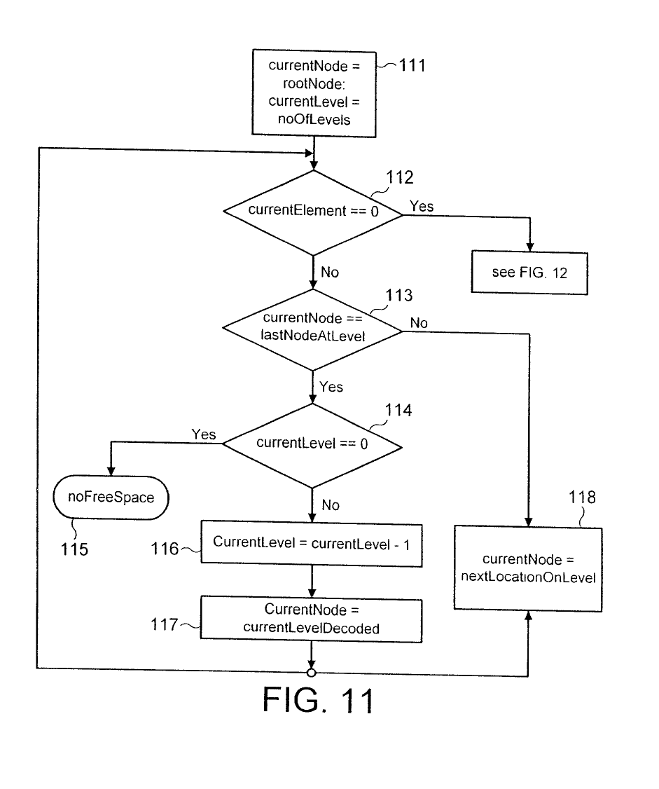

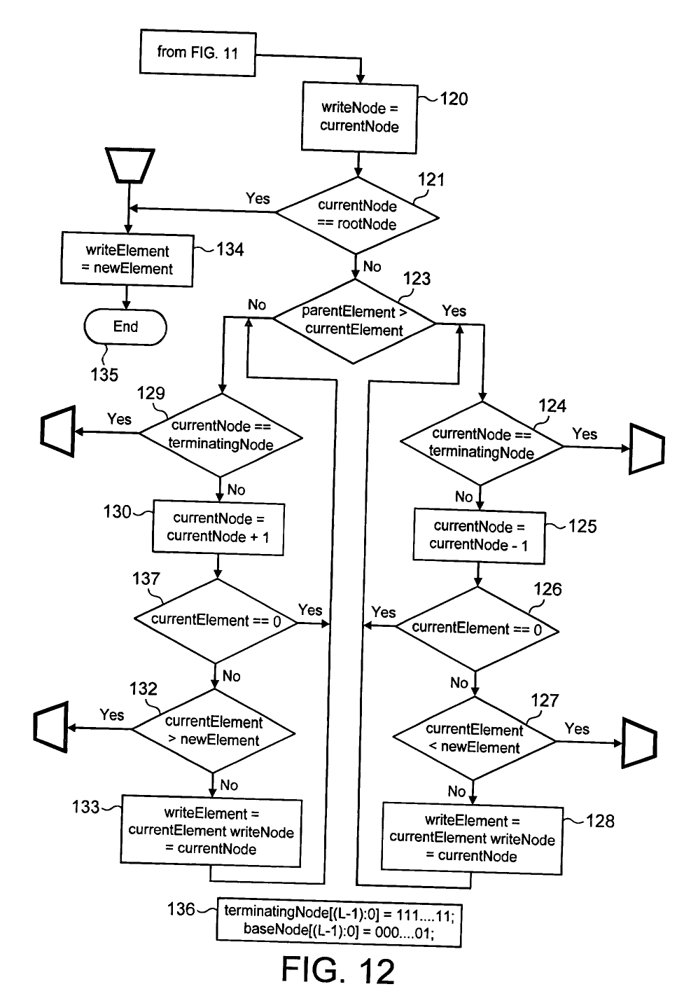

Stage 112 is a test whether the current element (the element stored at the current node) is zero. If it be zero, the procedure described in FIG. 12 will be followed. This is described later.

If the current element stored at the current node is non-zero, the algorithm tests whether the current node is the last node at the level (determined as previously described). If the current node is the last node at the level there is a further test 114 to determine whether the current level is zero (the lowest level of which node 108 is the base and node 109 is the terminating node).

If the current level is zero as determined by stage 114, there is no free space, as indicated by stage 115. The algorithm has reached node 109 as shown in FIG. 10.

If the test 114 indicates that the current node is the last node at the level and the current level is non-zero, then the current level must be decremented (stage 116) and the current node set to the current level decoded (stage 117). This will direct the insertion process to the first node in the next level.

If tests 113 indicate the current node is not the last node at the level, then the current node is reset to be the next location on the level stage 118, and the algorithm reverts to stage 112.

FIG. 12 illustrates the insertion process in the event that the current node is set to the root node and the current element is zero. The process in FIG. 12 includes a shuffling algorithm Stage 120 defines ‘writeNode’ as equal to the current node, in preparation for a writing operation. Stage 121 is a test for the current node being the root node. If it is, then the new element is written into the node, stage 134 and the process ends (stage 135).

If the current node is not the root node then a test (123) must be made to determine whether the parent element (the element stored in the parent of the current node) is greater than the current element.

If the parent element is greater than the current element, the next test is whether the current node is equal to the base node stage 124

If the current node is not equal to the base node (124), the current node is set (stage 125) to one fewer than the current node. If the current element is non-zero (stage 126), and the current element is less than the new element (stage 127), then the write element is the current element and the write node is the current node (stage 128).

If the parent element is greater than the current element and the current node is not equal to the terminating node (stage 129) the current node is set (stage 130) to one more than the current node. If the current element is non-zero (stage 131), and the current element is greater than the new element (stage 132) then the new element is written (134) and the process ends (stage 135). If the current element is not greater than the news element then the write element is set to the current element, the write node is set to the current node (stage 133) and this sub-process recycles.

A specific example of the insertion of four elements in an initially unoccupied trie now follows. It is assumed that the elements are x₁ to x4 where x₁>x₂>x₃>x₄. In each case the stages shows in FIGS. 11 and 12 are listed with the result (Yes or No) given for each test in the path. For the sake of simplicity it is assumed that the search tree has only three levels, e.g. a root node, level 2, two nodes at level 1 and four nodes at level 0, so that the first node at the last-mentioned level is the base node. This tree corresponds to nodes 101 to 105 in FIG. 10 (identifiable with 3-bit addresses).

(a) Element x₁ stages 111-112 (YES)-120-121 (YES)-134-135. Thus x₁ is stored at the root node.

(b) Element x₂ stages 111-112 (NO)-113 (YES)-114 (NO)-116-117-112 (YES)-120-121 (NO)-123 (YES)-124 (NO)-125-126 (YES)-124 (YES)-134-135.

x₂ is stored in the leftChildNode of the root node.

(c) Element x₃ stages 111-112 (NO)-113 (YES)-114 (NO)-116-117-112 (NO)-113 (NO)-118-112 (YES)-120-121 (NO)-123 (YES)-124 (NO)-125-126 (YES)-124 (NO)-125-126 (NO)-127 (NO)-128-124 (NO)-125-126 (YES)-124 (NO)-125-126 (NO)-127 (NO)-128-124 (NO)-125-126 (YES)-124 (YES)-134-135.

x₃ is stored in the rightChildNode of the root node, thereby maintaining the balance of the tree.

(d) Element x₄ stages 111-112 (NO)-113 (YES)-114 (NO)-116-117-112 (NO)-113 (NO)-118-112 (NO)-113 (YES)-114 (NO)-116-112 (YES)-120-121 (NO)-123 (YES)-124 (YES)-134-135.

x₄ is stored in the baseNode of the tree.

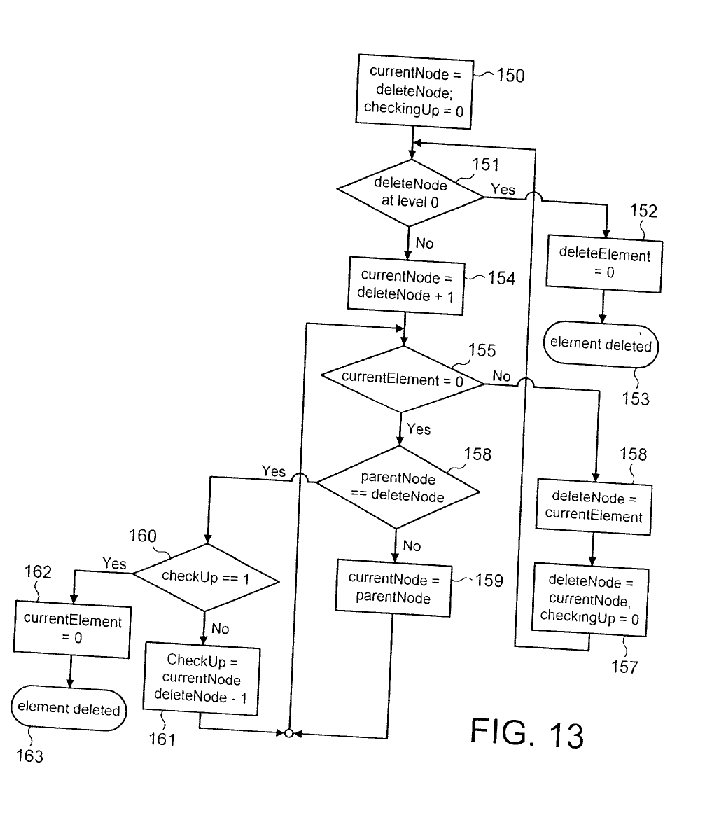

FIG. 13 is a flow chart for a deletion algorithm. This is not essential to the invention in its broadest form but, particularly in the context of the switch it is desirable to be able to remove entries selectively, for example as part of an ‘ageing’ process in which new entries (e.g. MAC addresses) are given a ‘time stamp’ (eg a number in a recycling series) and at appropriate intervals entries which are too old by comparison of the time stamp with the state of an ageing clock are removed to make additional room for new entries.

The deletion process begins at stage 150 to set current node to ‘delete node’ and a ‘checking-up’ flag to zero. Stage 151 is a test to determine whether the node to be deleted is at level zero. If it is, then without further tests the element is set to zero (152) and deleted (153).

If the node is not at level zero then stage 154 augments the current node. If the current element is zero (155), then stage 158 tests whether the parent node is equal to the delete node. If it is not, the current node is set to the parent node and tests 155, 158 and 159 recur. If the parent node is equal to the delete node then after stage 160, a monitoring stage, and there is a checkup, the current element is set to zero (162) and the element is deleted (163). If the check-up has not been made, then the check-up is set to the current node is decremented by unity and the process reverts to stage 155.

1. A binary search tree comprising:
a multiplicity of address nodes each operable to store a data element, the nodes having pre-determined addresses and organised in a multiplicity of levels, the nodes including a root node and for each node at each level except the lowest level two child nodes in the immediately lower level, whereby the address of each child node is computable from the address of the respective node having that child node; and
a hardware engine for the insertion of elements in the nodes, said hardware engine being operable to make a search for the highest an available node for the insertion of a new element and to search in a pattern in which all the nodes at each level beginning at the highest are searched before the search continues to the next lower level.

2. A binary search tree according to claim 1 wherein for each current node in said search the search comprises:
(a) determining whether a non-zero element is stored at the current node.
(b) determining, in the event that said non-zero element is stored, whether the current node is the last node at a current level of the tree.
(c) determining, if said current node is said last node, whether the current level is the lowest level of the tree.
(d) decrementing, if said current level is not the lowest level, the current level of the search and changing the current node to the first node of the next lower level of the tree, and
(e) setting, if said current node is not the last node at the current level, the current node to be the next node at the same level.

3. A binary search tree according to claim 2 wherein said engine, when the current node is at available for the storage of a new element, causes the writing of a new element.

4. A binary search tree according to claim 2 wherein said engine, when said current node is available for the storage of a new element, is operative
(I) to insert the new element if the current node is the root node, or when the current element is not the root node.
(II) to determine whether the new element is greater or less than the element stored at the parent node of the current node and to increment or decrement the current node respectively, and
(III) to insert the new element in accordance with an examination of the availability of the current node and a comparison of the magnitudes of the new element and the current element if any stored at the current node.

5. A method of establishing entries in a binary search tree, said binary search tree comprising a multiplicity of address nodes each operable to store a data element, the nodes having pre-determined addresses and organised in a multiplicity of levels, the nodes including a root node and for each node at each level except the lowest level two child nodes in the immediately lower level, whereby the address of each child node is computable from the address of the respective node having that child node
said method comprising examining the nodes in a predetermined pattern to find a highest available node, said pattern requiring all the nodes at each level beginning at the highest to be examined before any node in the next lower level is examined.

6. A method according to claim 5 wherein said method comprises, for each current node that is examined
(a) determining whether a non-zero element is stored at the current node.
(b) determining, in the event that said non-zero element is stored, whether the current node is the last node at a current level of the tree.
(c) determining, if said current node is said last node, whether the current level is the lowest level of the tree.
(d) decrementing, if said current level is not the lowest level, the current level of the search and changing the current node to the first node of the next lower level of the tree, and
(e) setting, if said current node is not the last node at the current level, the current node to be the next node at the same level.
